(19) United States
(12) Patent Application Publication
(10) Pub. No.: US 2010/0229808 A1
(43) Pub. Date: Sep. 16, 2010

(54) HEAT TRANSFERRING DEVICE AND METHOD TO BOOST FUEL ECONOMY IN MOTOR VEHICLES

(76) Inventor: Kenneth Lee Demmith, Green Bay, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/741,135

(22) PCT Filed: Oct. 30, 2008
(86) PCT No.: PCT/US08/81687

§ 371 Date: May 3, 2010

Related U.S. Application Data
(60) Provisional application No. 60/984,387, filed on Nov. 1, 2007.

(51) Int. Cl. F01P 9/00; F02G 5/00

(52) U.S. Cl. 123/41.01; 123/557

(57) ABSTRACT

A heat exchanging device (10) and method for boosting fuel economy in the internal combustion engines of motor vehicles uses a shell and tube structure whereby that portion of the fuel line, i.e. an inner structure (20), that is downstream from the fuel line filter (204), the fuel pump (202) and the fuel tank (200), and upstream from the fuel injector (206) or carburetor, is placed in heat-exchanging relationship with a portion of the cooling system, i.e. an outer structure (40), that is downstream from the engine block (102) and upstream of the heater core (114) of the motor vehicle.

This application claims the benefit and priority of U.S. Provisional Patent Application No. 60/984,387 filed Nov. 1, 2007.

### FIELD OF THE INVENTION

The present invention relates generally to devices that are used with the internal combustion engine of a motor vehicle. More specifically, it relates to a shell and tube heat exchanger that is used to transfer heat generated within an internal combustion engine to a portion of the fuel line such that the fuel is heated prior to combustion thereby realizing an increase in the mileage obtained per unit of fuel used by the motor vehicle as compared to conventional use of the internal combustion engine. It also relates to a method for boosting fuel economy in a motor vehicle wherein the heat exchanger is disposed within a particular position relative to the fuel line and relative to the cooling system of the motor vehicle.

### BACKGROUND OF THE INVENTION

Shell and tube heat exchangers are known in the art. Such heat exchangers typically utilize two fluids, of different starting temperatures, that flow through the heat exchanger. One fluid flows through a centrally-disposed tube and the other fluid flows outside of the tube but inside a shell that overlays the tube, or a portion of it. Heat from one fluid is thus transferred from one fluid to the other through the tube walls. There can be, and in fact are, many variations of the shell and tube design that exist in many different areas of technology.

In the area of fuel economy, however, which area is continuing to be a major factor in the movement away from fossil fuels to other fuels, the harsh reality is that gasoline will continue to be the major fuel for motor vehicles for many years to come. This will likely continue until we are able to eventually wean ourselves away from what is currently the almost exclusive use of gasoline as a fuel source for motor vehicles in this country. Accordingly, it was a goal of this inventor to utilize a shell and tube configuration to remove heat from the coolant that flows within the cooling system of a motor vehicle to the fuel passing through the fuel system to the combustible engine. Another goal, however, is to utilize such a shell and tube configuration in such a way that has never before been used with motor vehicles of current manufacture. In this way, motor vehicles can be retrofitted with a fuel economy boosting device and new vehicles may be considered for fabrication with it as original equipment as well.

### SUMMARY OF THE INVENTION

The present invention provides such a device that, when used properly, helps to boost fuel economy in a motor vehicle wherein a heat exchanger is disposed within a particular position relative to the fuel line and relative to the cooling system of the motor vehicle. Accordingly, the present invention is considered to cover the device itself as well as the method in which it is used.

The device of the present invention provides for a heat exchanging device that uses a shell and tube structure whereby that portion of the fuel line, i.e. the tube, that is downstream from the fuel line filter, the fuel pump and the fuel tank, and upstream from the fuel injector or carburetor, is placed in heat-exchanging relationship with a portion of the cooling system, i.e. the shell, that is downstream from the engine and upstream from the heater core of the motor vehicle. When configured and placed in this fashion, fuel savings of up to twenty percent (20%) has been realized in tests conducted on behalf of this inventor.

The foregoing and other features of the device and method of the present invention will be apparent from the detailed description that follows.

### BRIEF DESCRIPTION OF THE DRAWINGS

FIG. 1 is a top, front and left side perspective view of a preferred embodiment of a heat transferring device that is constructed in accordance with the present invention.

FIG. 2 is a schematic diagram of the typical cooling system and typical fuel system of a motor vehicle that would use the heat transferring device and method of the present invention.

FIG. 3 is an enlarged and partially cross-sectioned front elevational view of the heat transferring device shown in FIG. 1.

### DETAILED DESCRIPTION OF THE INVENTION

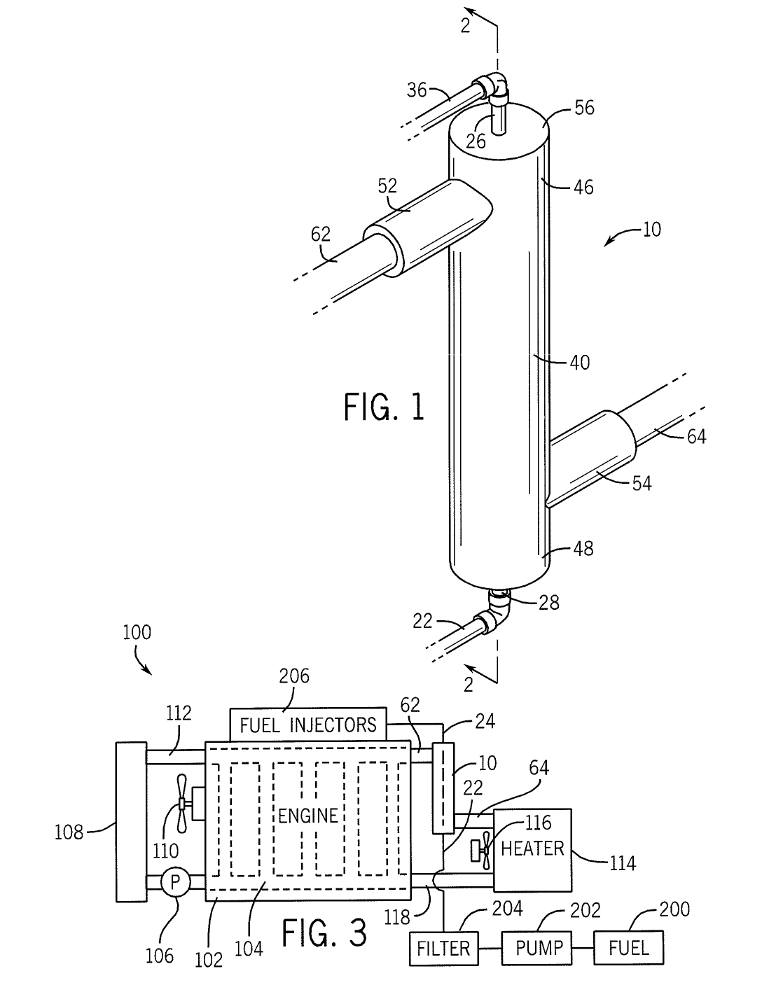

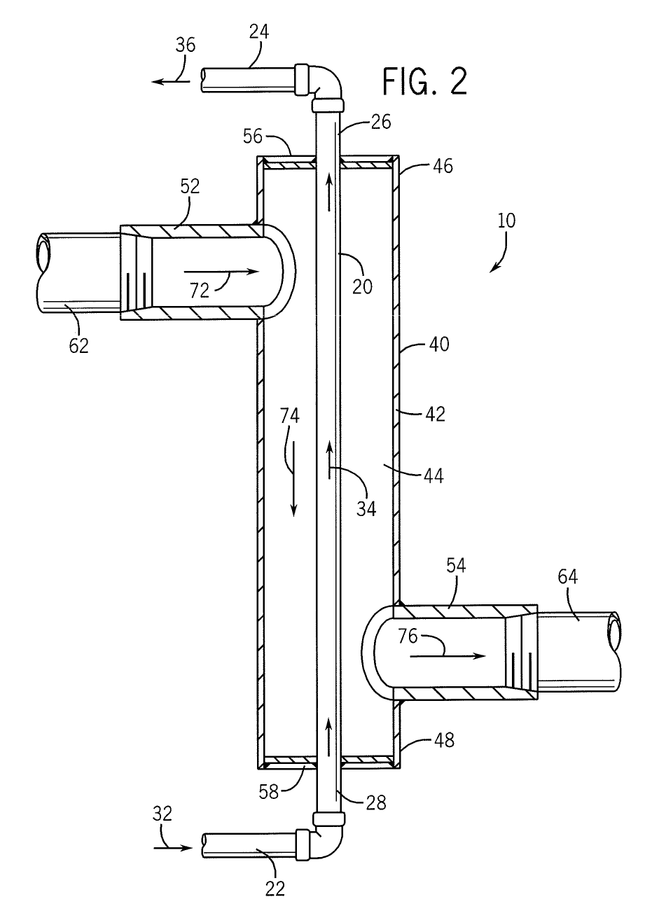

Referring now to the drawings in detail, wherein like numbered elements correspond to like elements throughout, FIG. 1 is a perspective view of a preferred embodiment of the heat transferring device, generally identified 10, which is constructed in accordance with the present invention. Referring specifically to FIG. 2, which is a partially cross-sectioned front elevational view of the heat transferring device 10 shown in FIG. 1, it will be seen that the heat transferring device 10 comprises two principal structures. The first principal structure is an inner tube-like cylindrical structure 20 that is partially surrounded by a second structure, which is an outer cylindrical structure 40.

Again referring to FIG. 2, it will be seen that the inner tube-like cylindrical structure 20 comprises a first end 26 and second end 28. The first end 26 of the inner cylindrical structure 20 is sealingly connected to a fuel-line outlet 24. Similarly, the second end 28 of the inner cylindrical structure 20 is sealingly connected to a fuel line inlet 22. In application, there is an inflow 32 of fuel through the fuel line inlet 22, a through flow 34 of fuel within the inner cylindrical structure 20 and an outflow 36 of fuel at the fuel line outlet 24.

Continuing with reference to FIG. 2, it will be seen that the outer cylindrical structure 40 essentially “overwraps” a portion of the inner cylindrical structure 20. The outer cylindrical structure 40 including a sidewall 42, the sidewall having a first end 46 and a second end 48. At the first end 46 of the outer cylindrical structure 40 is a first sealed end cap 56. Similarly, at the second end 48 of the outer cylindrical structure 40 there is a second sealed end cap 58. The first and second sealed end caps 56, 58, respectively, each include an aperture (not shown) through which a portion of the inner cylindrical structure 20 passes. The sidewall 42 and the sealed end caps 56, 58 of the outer cylindrical structure 40 comprise and form an inner chamber 44 of the outer cylindrical structure 40.

In application, it will be seen that an inlet port 52 is sealingly provided at the first end 46 of the outer cylindrical structure 40 as is an outlet port 54 that is located at the second end 48 of the outer cylindrical structure 40. See also FIG. 1. The inlet port 52 of the outer cylindrical structure 40 is sealingly attached to a coolant inlet line 62. Similarly, the outlet port 54 of the outer cylindrical structure 40 is sealingly connected to a coolant outlet line 64.

Also in application is the fact that the coolant inlet line 62 and the inlet port 52 of the outer cylindrical structure 40 provide for the inlet flow 72 of coolant into the outer cylindrical structure chamber 44. Within the inner chamber 44 of the outer cylindrical structure 40, a through flow 74 of coolant is provided. Coolant then leaves the inner chamber 44 of the outer cylindrical structure 40 by means of the outlet port 54 of the outer cylindrical structure 40 and the coolant outlet line 64 thereby providing for an outflow 76 of coolant.

During the time that the coolant flows 74 through the outer cylindrical structure 40 and the fuel flows 34 through the inner cylindrical structure 20, there is an exchange of heat between those two elements whereby the heat contained in the through flow 74 of coolant is effectively transferred to the through flow 34 of fuel that passes through the inner cylindrical structure 20, the inner cylindrical structure 20 being constructed of a heat-conductive metal material in the preferred embodiment.

In application, it will be seen in FIG. 3 that the heat exchanging device 10 of the present invention is utilized within the combined fuel system and cooling system, generally identified 100, of a typical internal combustion engine 102 that is used in a typical motor vehicle (not shown) as is well known in the art. As shown schematically, the engine 102 contains a plurality of flow-through chambers 104 which carry heat from the cyclical combustions occurring within the piston bores (not shown) within the engine block 102. This flow is generated by a pump 106 that pushes coolant through a radiator 108, the radiator 108 being cooled by a combination of air flow that moves through the engine compartment simply by movement of the motor vehicle during operation and by fan-cooled air that is pushed across the radiator 108 by a fan 110. As the coolant flows back into the engine 102 by means of an inlet coolant line 112, it is carried through the engine and exits the engine at the line 62 which is then passed through the heat exchanging device 10 and through a line 64 to a heater core 114 that allows heated air to be blown by means of a fan 116 into the passenger compartment of the automobile (not shown).

It is to be understood that the heater core 114 is also a radiator-like device that is typically located under the dashboard of the vehicle and is solely used for heating the passenger compartment. The hot coolant, passing from the vehicle's engine at about 210° F., is passed through a winding tube of the core 114, the tubing also including fins to increase the surface for heat transfer to the air that is forced past them by the fan 116. Hot coolant passing through the heater core 116 gives up heat before returning to the engine cooling circuit. As coolant exits the heater core 114 by means of the coolant line 118, the entire cycle is repeated.

As alluded to above, as the heated coolant passes through the heat exchanging device 10, the fuel passing through it is heated as well. As shown in FIG. 3, the fuel system of the automobile comprises a fuel supply 200, the fuel being pumped 202 and then filtered 204 on its way to fuel injectors 206 that inject fuel into the combustion chambers (not shown) of the internal combustion engine. As also alluded to above, the coolant passing to the heat exchanging device 10 does so at about 210° F. It is also known to this inventor that gasoline combusts at about 400° F. and flames over at about 300° F., which is well above the temperature of the coolant. Accordingly, there is no problem of pre-combustion of the gasoline fuel that passes through the heat exchanging device 10. This should not be a problem as the internal cylindrical structure 20 is completely sealed relative to the outer cylindrical structure 40.

It has also been found by this inventor that drawing the heat from the coolant at the point just upstream of the heater core 114 optimizes performance. Performance also appears to be optimized where the overall length of the exposed internal cylindrical structure 20 within the chamber 44 of the outer cylindrical structure 40 is about three and one-half inches. Further optimization occurs where the internal cylindrical structure 20 is a one-eighth inch inner diameter tube and the outer cylindrical structure 40 is a three-quarters inch diameter tube.

Field testing of the heat exchanging device 10 was conducted using road load matching procedures and technique in accordance with SAE J2264 chassis dynamometer simulation. As a result, it was determined that up to a fifteen percent (15%) boost in miles per gallon has been realized in various types of motor vehicles using the device 10. Typical energy conservation resulted in anywhere from a three percent (3%) boost in miles per gallon to the fifteen percent figure mentioned above. The device 10 has also been used in diesel engine vehicles where energy conservation valves were in the twenty percent (20%) range. There is no doubt in the mind of this inventor that the increase in mileage is due to the utilization of the device 10 as outlined above.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept.

The details of the invention having been disclosed in accordance with the foregoing, I claim:

1. A heat transferring device (10) for use within the combined fuel system and cooling system (100) of an internal combustion engine, said engine cooling system (100) comprising a first coolant line (62) that carries coolant (72) away from the engine's engine block (102) and a second coolant line (64) that carries coolant (76) towards a heater core (114), said fuel system comprising a first fuel line (22) that carries fuel (32) away from the engine's fuel pump (202) and a second fuel line (24) that carries fuel (36) towards one or more fuel injectors (206) that inject fuel into the combustion chambers of the internal combustion engine (102), which comprises
an inner structure (20),
an outer structure (40), said outer structure (40) sealingly surrounding a portion of the inner structure (20),
an inner structure inlet (28) that is sealingly attached to the first fuel line (22),
an inner structure outlet (26) that is sealingly attached to the second fuel line (24),
an outer structure inlet port (52) that is sealingly attached to the first coolant line (62), and
an outer structure outlet port (54) that is sealingly attached to the second coolant line (64).

2. The heat transferring device (10) of claim 1 wherein the inner structure (20) is substantially cylindrical.

3. The heat transferring device (10) of claim 2 wherein the outer structure (40) is substantially cylindrical.

4. The heat transferring device (10) of claim 1 wherein the outer structure (40) comprises a first end (56) having an aperture defined within it, a second end (58) having an aperture defined within it, and a chamber structure (44) extending between the first end (56) and the second end (58), the inner structure (20) passing through the end apertures of the outer structure (40) and through the chamber structure (44), the inner structure (20) being sealingly attached to the first end (56) and the second end (58) of the outer structure.

5. The heat transferring device (10) of claim 4 wherein the inner structure (20) and the outer structure (40) are each substantially cylindrical.

6. The heat transferring device (10) of claim 5 wherein the inner structure (20) is comprised of a heat-conductive metal material.

7. A method for transferring heat from the cooling system (100) of an internal combustion engine to the fuel system (100) of the internal combustion engine, said engine comprising an engine block (102), a heater core (114), a fuel pump (202) and one or more fuel injectors (206), which method comprises the step of
providing a first coolant line (62) that carries coolant (72) away from the engine's engine block (102),
providing a second coolant line (64) that carries coolant (76) towards the engine's heater core (114),
providing a first fuel line (22) that carries fuel (32) away from the engine's fuel pump (202),
providing a second fuel line (24) that carries fuel (36) towards the engine's one or more fuel injectors (206),
providing an inner structure (20),
providing an outer structure (40),
sealingly surrounding a portion of the inner structure (20) with said outer structure (40),
providing an inner structure inlet (28),
sealingly attaching the inner structure inlet (28) to the first fuel line (22),
providing an inner structure outlet (26),
sealingly attaching the inner structure outlet (26) to the second fuel line (24),
providing an outer structure inlet port (52),
sealingly attaching the outer structure inlet port (52) to the first coolant line (62),
providing an outer structure outlet port (54), and
sealingly attaching the outer structure outlet port (54) to the second coolant line (64).

8. The heat transferring method of claim 7 wherein the inner structure (20) is substantially cylindrical.

9. The heat transferring method of claim 8 wherein the outer structure (40) is substantially cylindrical.

10. The heat transferring method of claim 7 wherein the outer structure (40) provided comprises a first end (56) having an aperture defined within it, a second end (58) having an aperture defined within it, and a chamber structure (44) extending between the first end (56) and the second end (58), the inner structure (20) passing through the end apertures of the outer structure (40) and through the chamber structure (44), the inner structure (20) being sealingly attached to the first end (56) and the second end (58) of the outer structure (40).

11. The heat transferring method of claim 10 wherein the inner structure (20) and the outer structure (40) provided are each substantially cylindrical.

12. The heat transferring device of claim 11 wherein the inner structure (20) provided is comprised of a heat-conductive metal material.
